(19) United States
(12) Patent Application Publication
(10) Pub. No.: US 2019/0297574 A1
(43) Pub. Date: Sep. 26, 2019

(54) WIRELESS COMMUNICATION DEVICE PROVIDING TWO-WAY COMMUNICATION WITH LOW POWER CONSUMPTION

(71) Applicant: SAMSUNG SDS CO., LTD., Seoul (KR)

(72) Inventors: Gwang Hee CHOI, Seoul (KR); Young Jin SONG, Seoul (KR); Young Min AHN, Seoul (KR)

(73) Assignee: SAMSUNG SDS CO., LTD., Seoul (KR)

(21) Appl. No.: 16/117,142

(22) Filed: Aug. 30, 2018

(30) Foreign Application Priority Data
Mar. 20, 2018 (KR) 10-2018-0032005

(51) Int. Cl. H04W 52/02; H04W 76/25; G07C 9/00; H04L 29/12

(52) U.S. Cl. CPC H04W 52/0222; H04W 76/25; H04W 84/12; H04L 61/256; G07C 9/00309

(57) ABSTRACT

There is provided a wireless communication device capable of providing two-way communication while minimizing the consumption of power so as to be continuously operable for a long period of time simply with battery power, without the aid of a constant power source. The wireless communication device includes: a wireless network interface connected to an access point (AP), which provides wireless local area network (WLAN) access; and a session maintenance packet transmission controller controlling the wireless network interface to repeatedly transmit a session maintenance packet, wherein the session maintenance packet includes a MAC keep-alive message, an address resolution protocol (ARP) response message, and a hole punching message.

This application claims the benefit of Korean Patent Application No. 10-2018-0032005, filed on Mar. 20, 2018, in the Korean Intellectual Property Office, the disclosure of which is incorporated herein by reference in its entirety.

### BACKGROUND

### 1. Field

The present disclosure relates to a wireless communication device, and more particularly, to a wireless communication device capable of providing two-way communication while consuming less power.

### 2. Description of the Related Art

Wireless communication technology is provided. As the Internet of Things (IoT) technology has become commercially available, small wireless communication devices such as IoT sensors have increasingly been used in various fields. However, many small wireless communication devices are operated with batteries, rather than with constant power sources, for reasons such as installation environment. Thus, small wireless communication devices need to lower their power consumption to be operable for a long period of time.

To reduce the consumption of power, a battery power-based small wireless communication device periodically wakes up from a sleep mode to transmit data and returns to the sleep mode. This type of small wireless communication device, however, can only provide one-way communication with an external device.

For bilateral communication with a battery power-based small wireless communication device, a hub device may be provided separately for the small wireless communication device. For example, if the small wireless communication device is a Wi-Fi device, a Wi-Fi hub may be provided between an access point (AP) and the small wireless communication device. Generally, the Wi-Fi hub is powered by a constant power source. The Wi-Fi hub receives and stores data to be transmitted to the small wireless communication device, and transmits the stored data when the small wireless communication device wakes up from a sleep mode. The Wi-Fi hub can provide a two-way communication function, but it is inconvenient to provide the Wi-Fi hub separately.

Therefore, a wireless communication device capable of providing a two-way wireless communication function while reducing the consumption of power is needed.

### SUMMARY

Exemplary embodiments of the present disclosure provide a wireless communication device capable of maintaining its connection to an external device such as a server to be able to perform two-way communication with the external device while consuming less power.

Exemplary embodiments of the present disclosure also provide a wireless communication device capable of providing a two-way communication function with low power consumption by controlling response latency for signals, received from an external device, according to the pattern of use thereof and a method of controlling the wireless communication device.

Exemplary embodiments of the present disclosure also provide a server device and a method for reducing the power consumption of a wireless communication device by controlling the response latency of the wireless communication device based on the history of requests made for the wireless communication device via a wireless connection.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to the present disclosure, there is provided a wireless communication device capable of providing two-way communication while minimizing the consumption of power so as to be continuously operable for a long period of time simply with battery power, without the aid of a constant power source.

According to an aspect of the present disclosure, there is provided a wireless communication device. The device comprises a wireless network interface connected to an access point (AP), which provides wireless local area network (WLAN) access and a session maintenance packet transmission controller controlling the wireless network interface to repeatedly transmit a session maintenance packet, wherein the session maintenance packet includes a MAC keep-alive message, an address resolution protocol (ARP) response message and a hole punching message. According to an aspect of the present disclosure, there is provided a server device. The server device comprises a network interface providing a connection to a wireless communication device and a connection to a user terminal, a memory storing one or more instructions; and a processor executing the one or more instructions, wherein the one or more instructions include an instruction receiving a request for the wireless communication device from the user terminal and transmitting a control signal for the wireless communication device in response to the received request, an instruction logging at least one of the reception of the request and the transmission of the control signal so as to configure a data processing log, an instruction determining a beacon reception interval of the wireless communication device based on a result of analyzing the data processing log, and an instruction transmitting a beacon reception interval control signal that changes the beacon reception interval of the wireless communication device to the determined beacon reception interval to the wireless communication device.

According to an aspect of the present disclosure, there is provided a wireless communication device. The wireless communication device comprises a wireless network interface connected to an AP which provides WLAN access, a beacon reception controller changing a beacon reception interval for beacons transmitted by the AP and a battery supplying power wherein the beacon reception controller changes the beacon reception interval based on the level of the battery.

According to an aspect of the present disclosure, there is provided a wireless communication device. The wireless communication device comprises a wireless network interface connected to an AP, which provides WLAN access and a beacon reception controller changing a beacon reception interval for beacons transmitted by the AP, wherein the beacon reception controller changes the beacon reception interval according to a beacon reception interval control signal received from an external device via the wireless network interface.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIGS. 1 and 2 are schematic views illustrating two-way communication systems according to some exemplary embodiments of the present disclosure;

FIG. 3 is a schematic view for explaining packets transmitted or received by a wireless communication device, according to some exemplary embodiments of the present disclosure;

FIG. 4 is a signal flowchart illustrating how to change the beacon reception interval of the wireless communication device under the control of an external device, according to some exemplary embodiments of the present disclosure;

FIG. 5 is a signal flowchart illustrating how to maintain a session between a wireless communication device and an access point (AP) through the transmission of a session maintenance packet, according to some exemplary embodiments of the present disclosure;

FIG. 6 is an exemplary block diagram of a wireless communication device according to an exemplary embodiment of the present disclosure;

FIG. 7 is another exemplary block diagram of the wireless communication device according to an exemplary embodiment of the present disclosure;

FIG. 8 is an exemplary block diagram of a server device according to an exemplary embodiment of the present disclosure;

FIG. 9 is another exemplary block diagram of the server device according to an exemplary embodiment of the present disclosure;

FIG. 10 is a flowchart illustrating a two-way communication method according to an exemplary embodiment of the present disclosure;

FIGS. 11 through 12 are detailed flowcharts illustrating steps of the two-way communication method of FIG. 10;

FIGS. 13 and 14 are flowcharts illustrating a two-way communication control method according to an exemplary embodiment of the present disclosure; and

FIG. 15 is a schematic view illustrating the hardware configuration of the server device according to an exemplary embodiment of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

It will be understood that the terms “comprise” and/or “comprising” when used herein, specify some stated components, steps, operations and/or elements, but do not preclude the presence or addition of one or more other components, steps, operations and/or elements.

The structure and operations of a two-way communication system according to an exemplary embodiment of the present disclosure will hereinafter be described with reference to

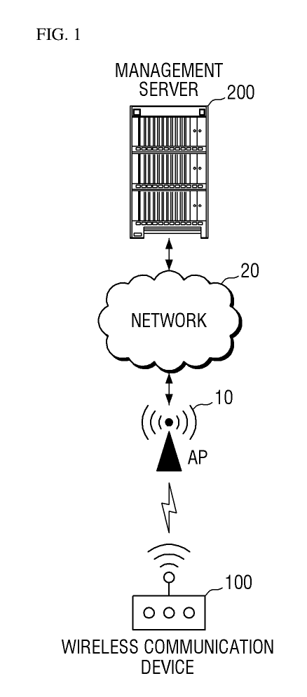

FIG. 1. The two-way communication system may include at least one of a management server 200, an access point (AP) 10, and a wireless communication device 100. Nearly any type of electronic device that can be connected to the AP 10 via a wireless communication channel may be used as the wireless communication device 100.

The wireless communication device 100 may be operated with a battery, rather than with a constant power source. The wireless communication device 100 can reduce the consumption of power when bidirectionally communicate with an external device such as the management server 200. Accordingly, a wireless communication device 100 operated with a battery can be benefited more than a wireless communication device 100 connected to a constant power source from the inventive concept of the present disclosure. However, a wireless communication device 100 connected to a constant power source should not be excluded from the scope of the inventive concept of the present disclosure.

The wireless communication device 100 can reduce the consumption of power by dynamically changing its beacon reception interval for beacons broadcast by the AP 10. Also, by generating a session maintenance packet of a new configuration and transmitting the session maintenance packet to the AP 10, the wireless communication device 100 can increase its session maintenance packet transmission interval as much as possible, while maintaining a session for two-way communication with an external device, and can reduce the consumption of power. This will be described later in further detail.

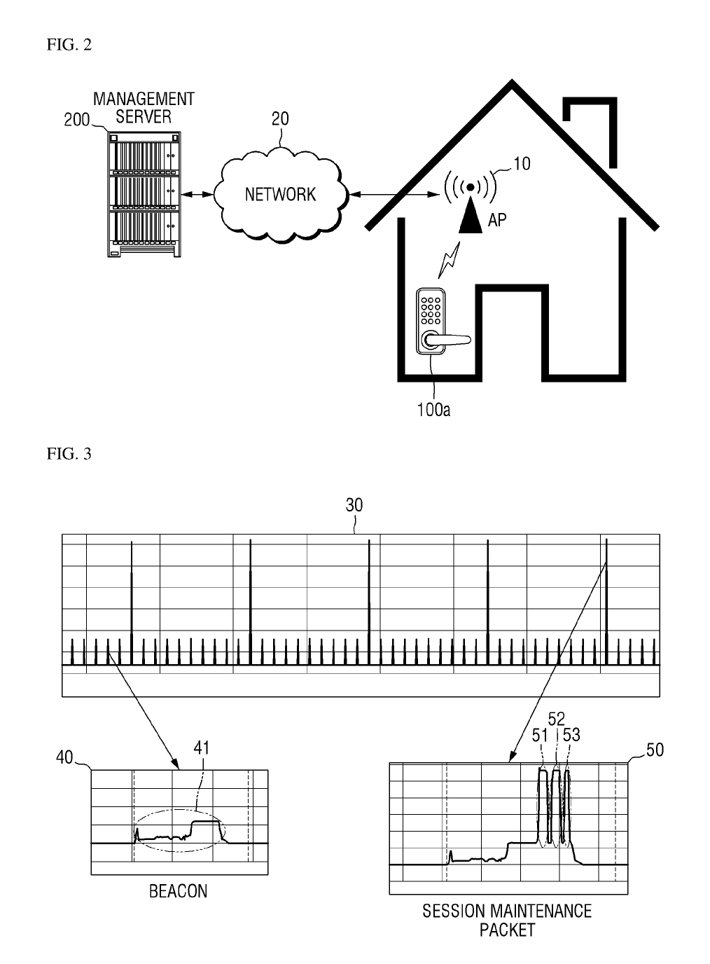

In one exemplary embodiment, as illustrated in FIG. 2, the wireless communication device 100 may be a door lock 100a. The door lock 100a, which may be installed at the front door of an apartment, may not be able to be powered by a constant power source because of restrictions on its installation location. The door lock 100a is generally operated with battery power. Thus, even if the door lock 100a is equipped with a Wi-Fi communication function, it may be unreasonable for the door lock 100a to consume too much power to be connected to an external device via the AP 10 for two-way communication, because of limited battery power. Thus, a power saving two-way communication technique according to some exemplary embodiments of the present disclosure, which is applicable to the door lock 100a, can be of great contribution to providing a constant two-way communication function to the door lock 100a.

Packets transmitted or received by the wireless communication device 100, according to some exemplary embodiments of the present disclosure, will hereinafter be described with reference to FIG. 3. FIG. 3 shows a signal capture result 30 in accordance with the transmission or reception of packets by the wireless communication device 100. The signal capture result 30 shows periodic beacon receptions 40 and repeated session maintenance packet transmissions 50. Referring to FIG. 3, a signal (51, 52, and 53) generated when the wireless communication device 100 transmits a session maintenance packet, unlike a signal 41 generated when a wireless communication device 100 receives a beacon, forms three peaks because the session maintenance packet transmitted by the wireless communication device 100 includes three messages.

To maintain a two-way communication session of the wireless communication device 100, a session maintenance packet is transmitted repeatedly. The session maintenance packet may be repeatedly transmitted either periodically or non-periodically.

In one exemplary embodiment, the same session maintenance packet may be repeatedly transmitted. In this exemplary embodiment, the session maintenance packet may include a MAC keep-alive message, an address resolution protocol (ARP) response message, and a hole punching message. In another exemplary embodiment, session maintenance packets having different configurations may be transmitted one after another repeatedly. For example, first through n-th session maintenance packets may be configured using at least some of a MAC keep-alive message, an ARP response message, and a hole punching message, and the first through n-th session maintenance packets may be sequentially transmitted repeatedly. For convenience, in the description that follows, it is assumed that the same session maintenance io packet is repeatedly transmitted.

Test results obtained using various types of APs show that the transmission interval of a session maintenance packet can be maximized if the session maintenance packet consists of a MAC keep-alive message, an ARP response message, and a hole punching message. It will hereinafter be described why the MAC keep-alive message, the ARP response message, and the hole punching message are the key elements for maximizing the session maintenance packet transmission interval of the wireless communication device 100, and at the same time, maintaining a session of the wireless communication device 100.

Hole punching, which is a type of network address translation (NAT) traversal technique, enables peer-to-peer (P2P) communication between hosts behind a network address translator. Here, the network address translator may be, for example, the AP 10, and one of the hosts may be the wireless communication device 100.

In a hole punching process, the wireless communication device 100 transmits a registry session message including private address information (e.g., a private IP address and port number) of the wireless communication device 100 and public address information (e.g., a public IP address and port number) of the wireless communication device 100 to a rendezvous server, which serves as a hole punching manager, and thus allows binding information of a counter host to be stored in the rendezvous server. Thereafter, in response to the wireless communication device 100 sending a message requesting a connection to the counter host to the rendezvous server, the rendezvous server transmits address information of the counter host to the wireless communication device 100, and the wireless communication device 100 transmits data to the counter host via P2P communication using the address information of the counter host, transmitted by the rendezvous server. In this manner, a hole for P2P communication is created in the AP 10, to which the wireless communication device 100 is connected.

To be connected to the management server 200, the wireless communication device 100 may preferably store address information of the management server 200. The address information of the management server 200 may be stored in storage means (e.g., a nonvolatile memory) of the wireless communication device 100 at the time of the manufacture of the wireless communication device 100. In P2P communication, the management server 200 may serve as both the rendezvous server and the counter host. After booting up, the wireless communication device 100 opens a P2P communication session with the management server 200 by transmitting a registry session message and a P2P communication request message to the management server using the address information of the management server 200. Specifically, the wireless communication device 100 and the management server 200, which is the counter host of the P2P communication session opened by the wireless communication device 100, exchange address information in the form of peer information and exchange P2P data using the exchanged address information, and in the AP 10, to which the wireless communication device 100 is connected, mapping information is stored so that packets received from the management server 200 can be delivered to the wireless communication device 100. This process may be understood as being a process of creating a hole in the AP 10.

In one exemplary embodiment, an additional server may be provided in addition to the management server 200, which serves as the rendezvous server. In this exemplary embodiment, the wireless communication device 100 may transmit a registry session message and a P2P communication connection request message to the additional server.

The P2P communication session may be established through UDP hole punching (see section 5.1 of Request for comments (RFC) 3027) or through TCP hole punching.

To maintain the P2P communication session, the wireless communication device 100 repeatedly transmits predetermined dummy data to the management server 200 via the P2P communication session, and this will hereinafter be described in detail.

For example, if a UDP session from host A to host B is established through UDP hole punching, a network address translator (or an AP) connected to host A may close a hole for the UDP session if there is no traffic for more than a predetermined amount of time. Thus, in order to maintain the UDP session, traffic needs to be periodically provided to the network address translator. Each session maintenance packet may always include a hole punching message, a MAC keep-alive message, and an ARP response message, and the hole punching message may be a hole punching setting message at first, but may be a dummy data transmission message later on. That is, a first session maintenance packet may include a hole punching setting message, a MAC keep-alive message, and an ARP response message, and a second session maintenance packet may include a hole punching-based dummy data transmission message, a MAC keep- alive message, and an ARP response message. In this case, the wireless communication device 100 can connect a P2P session with the management server 200 by transmitting the first session maintenance packet to the management server 200 and can maintain the P2P session by repeatedly transmitting the second session maintenance packet.

The term “hole punching message,” as used herein, encompasses nearly all types of hole punching setting messages that are transmitted between hosts during hole punching setting, such as a registry session message, a connection request message, and the like, or encompasses nearly all types of dummy data transmission messages that can be transmitted in a P2P manner through hole punching after the creation of a hole.

Meanwhile, there is no particular standard as to “traffic non-flow time” for determining when to close a hole (i.e., when to delete information regarding the hole), and the traffic non- flow time is set to vary depending on the type of the network address translator or the AP. Thus, it is highly difficult to stably maintain the UDP session, regardless of the type of the AP, while minimizing the consumption of power. That is, in order to prevent the UDP session from being disconnected, the second session maintenance packet needs to be transmitted repeatedly, but frequent transmissions of the second session maintenance packet may inevitably increase the power consumption of the wireless communication device 100. Accordingly, in another exemplary embodiment, the wireless communication device 100 may repeatedly transmit the first session maintenance packet as if it were to repeatedly request hole punching setting. In this exemplary embodiment, the management server 200 may receive the same registry session message and the same connection request message over and over again. However, for a registry session message and a connection request message that have already been dealt with, the management server 200 simply operates to maintain existing P2P session information, and as a result, error can be prevented. In this case, the AP 10, to which the wireless communication device 100 is connected, may repeatedly perform hole punching setting, but still can deliver inbound packets provided thereto from the management server 200 to the wireless communication device 100. Thus, the P2P communication session between the wireless communication device 100 and the management server 200 can be maintained.

Meanwhile, since the AP 10 caches connections in a memory, the AP 10 can only manage a limited number of connections. Thus, the AP 10 deletes information regarding the oldest connection among all inactive connections. The term “information regarding connections,” as used herein, refers to information regarding connections on a MAC protocol layer. The AP 10 manages information regarding connections that need to be maintained, using a data structure such as a queue stored in the memory. That is, the oldest connection among the inactive connections is deleted from the data structure, in which case, the corresponding connection is disconnected. In response to a MAC keep-alive message being received, the AP 10 may insert information regarding a connection corresponding to the MAC keep-alive message in the data structure or increase the priority level of the information regarding the connection corresponding to the MAC keep-alive message in the data structure so that the information regarding the connection corresponding to the MAC keep-alive message can be continuously managed in the queue. Given this, the wireless communication device 100 repeatedly transmits a MAC keep-alive message so as for the AP 10 to continuously maintain a MAC protocol-layer connection for the wireless communication device 100.

It may be understood that the wireless communication device 100 repeatedly transmits a MAC keep-alive message so as for the AP 10 to continuously maintain a connection, and that the wireless communication device 100 repeatedly transmits a dummy data transmission message as a hole punching message so as for the AP 10 to continuously maintain a connection on a protocol layer (e.g., an UDP or TCP layer) higher than a MAC protocol layer.

If there exists no MAC address corresponding to the IP address of the wireless communication device 100 in the ARP cache of the AP 10, the AP 10 broadcasts an ARP request message, and the wireless communication device 100 unicasts an ARP response message together with its MAC address in response to the ARP request message. To prevent the MAC address corresponding to the IP address of the wireless communication device 100 from being lost from the ARP cache of the AP 10, the wireless communication device 100 may continuously update matching information stored in the ARP cache of the AP 10 by periodically transmitting an ARP response signal. In this manner, link disconnection that may be caused due to a MAC address being lost can be prevented. As a result, the hole in the AP 10 can be prevented from being closed, and can be maintained so that a two-way communication session between the wireless communication device 100 and the management server 200 can be maintained.

It has been described so far why a hole punching message, a MAC keep-alive message, and an ARP response message are the key elements for maximizing the session maintenance packet transmission interval of the wireless communication device 100, and at the same time, maintaining a session of the wireless communication device 100. In short, a hole punching message helps open and maintain a session between the wireless communication device 100 and the management server 200, a MAC keep-alive message helps prevent information regarding a MAC protocol-based connection between the wireless communication device 100 and the AP from being deleted from the queue in the memory of the AP 10, and an ARP response message helps continuously update information in the ARP cache of the AP 10 that matches the IP address of the wireless communication device 100 and a MAC address and thus helps prevent any link disconnection that may be caused due to a MAC address being lost. Since a session maintenance packet consists only of such essential messages as a hole punching message, a MAC keep-alive message, and an ARP response message, a session can be stably maintained between the wireless communication device 100 and the management server 200, and the amount of data transmitted between the wireless communication device 100 and the management server 200 can be minimized. Accordingly, the power consumption of the wireless communication device 100 can be effectively reduced. Also, since the session between the wireless communication device 100 and the management server 200 can be stably maintained even if the session maintenance packet transmission interval of the wireless communication device 100 is increased, the power consumption of the wireless communication device 100 can be further reduced.

In one exemplary embodiment, a session maintenance packet may sequentially include a hole punching message, a MAC keep-alive message, and an ARP response message. In this exemplary embodiment, the session maintenance packet may be a direction concatenation of the hole punching message, the MAC keep-alive message, and the ARP response message, a concatenation of the hole punching message, the MAC keep-alive message, and the ARP response message with delimiters interposed therebetween, or a concatenation of the hole punching message, first data, the MAC keep-alive message, second data, and the ARP response message.

The wireless communication device 100 may repeatedly transmit a session maintenance packet and may thus manage a session with the AP 10 not to be disconnected. Also, in order to reduce the consumption of power, the wireless communication device 100 may preferably transmit a session maintenance packet at as long intervals as possible, but not to the extent that the session with the AP 10 is disconnected. It will be described later how to determine the session maintenance packet transmission interval of the wireless communication device 100.

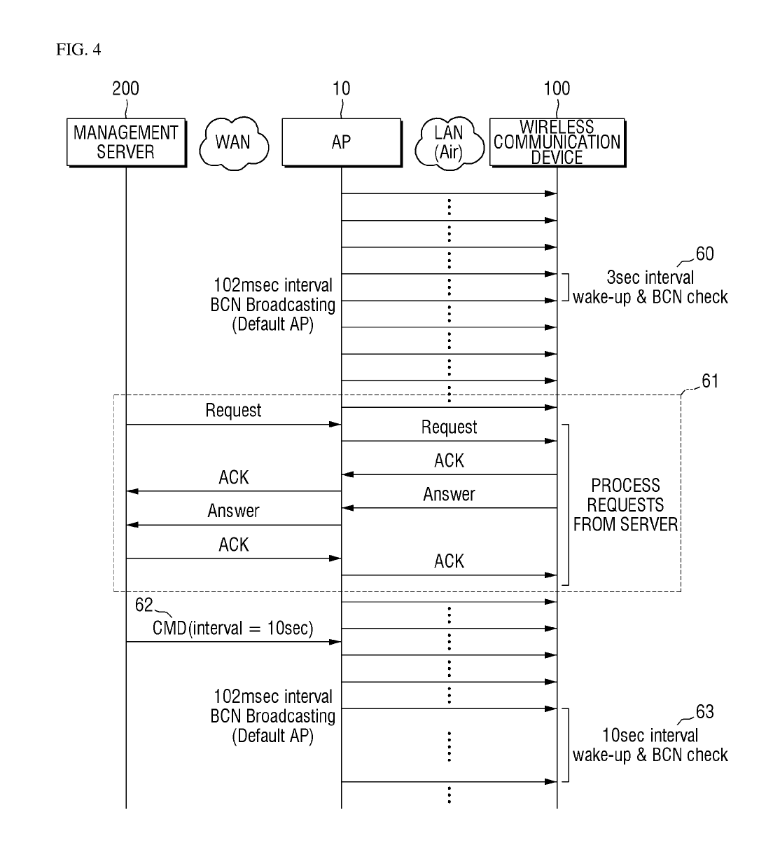

The wireless communication device 100 can reduce the consumption of power by transmitting, at as long intervals as possible, a session maintenance packet for increasing the session maintenance packet transmission interval of the wireless communication device 100 as much as possible, and at the same time, preventing a communication session from being disconnected. Also, the wireless communication device 100 can reduce the consumption of power by dynamically changing its beacon reception interval for beacons broadcast by the AP 10, and this will hereinafter be described with reference to FIG. 4.

According to the Wi-Fi standard, the AP 10 periodically broadcasts a beacon at intervals of about 102 msec. Receiving all beacons broadcast by the AP 10 increases the power consumption of the wireless communication device 100. Thus, as illustrated in FIG. 4, the wireless communication device 100 repeats periodically waking up from a sleep mode to receive a beacon and returning to the sleep mode at intervals of, for example, three seconds (60), and this means that the reception of signals by the wireless communication device 100 may be delayed by a maximum of three seconds. The wireless communication device 100 may process (61) a request signal transmitted by the management server 200 on the assumption that a beacon broadcast by the AP 10 has been received. Accordingly, the beacon reception interval of the wireless communication device 100 may indicate the response latency of the wireless communication device 100. That is, the longer the beacon reception interval of the wireless communication device 100, the longer the response latency of the wireless communication device 100.

A conventional Wi-Fi terminal has a fixed beacon reception interval. On the other hand, the wireless communication device 100 can dynamically change its beacon reception interval depending on the circumstances.

In one exemplary embodiment, the wireless communication device 100 can change its beacon reception interval on its own. For example, when the wireless communication device 100 is operated with a battery, the wireless communication device 100 may change its beacon reception interval based on the level of the battery. That is, if the level of the battery is below a threshold level, the wireless communication device 100 can increase its beacon reception interval and can thus reduce the discharge speed of the battery as much as possible. In this case, as already mentioned above, the response latency of the wireless communication device 100 may increase by as much as the beacon reception interval of the wireless communication device 100 increases.

In another exemplary embodiment, the wireless communication device 100 may change its beacon reception interval according to a beacon reception interval control signal received from the management server 200. FIG. 4 illustrates an example in which the management server 200 transmits (62) a beacon reception interval control signal including a predetermined beacon reception interval to the wireless communication device 100 and the wireless communication device 100 controls its beacon reception interval according to the beacon reception interval control signal. As illustrated in FIG. 4, the wireless communication device 100 may change (63) its beacon reception interval from three seconds to ten seconds.

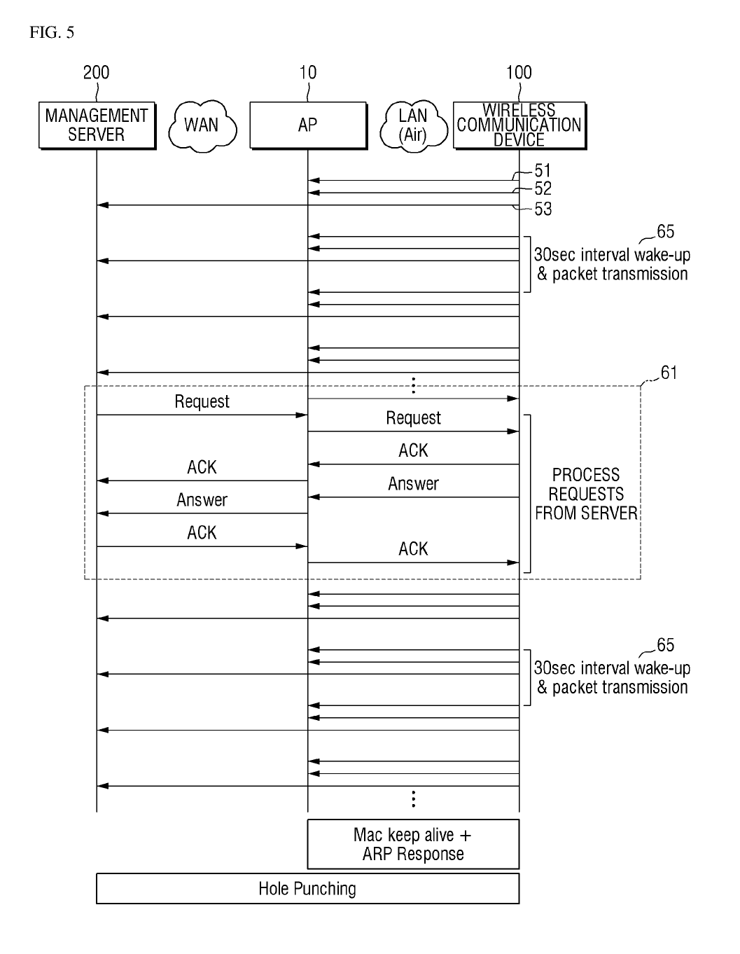

It will hereinafter be described how the session between the wireless communication device 100 and the AP 10 can be maintained through the transmission of a session maintenance packet with reference to FIG. 5. As already mentioned above, a session maintenance packet may include a MAC keep-alive message 51, an ARP response message 52, and a hole punching message 53. In order to repeatedly transmit the session maintenance packet periodically while reducing the consumption of power, the wireless communication device 100 repeats (65) waking up from a sleep mode to transmit a session maintenance packet and returning to the sleep mode.

The recipient of the MAC keep-alive message 51 and the ARP response message 52 is the AP 10, and the recipient of the hole punching message 53 is the management server 200.

FIG. 5 illustrates that all session maintenance packets repeatedly transmitted by the wireless communication device 100 include the MAC keep-alive message 51, the ARP response message 52, and the hole punching message 53, but as already mentioned above, the session maintenance packets repeatedly transmitted by the wireless communication device 100 may have different configurations. That is, in another exemplary embodiment, first through n-th session maintenance packets may be configured to consist of some or all of a hole punching message, a MAC keep-alive message, and an ARP response message, and the wireless communication device 100 may sequentially transmit the first through n-th session maintenance packets repeatedly and may thus repeatedly transmit the hole punching message, the MAC keep-alive message, and the ARP response message. That is, at least some of the transmission intervals of the hole punching message, the MAC keep-alive message, and the transmission interval of the ARP response message may differ from each other. Also, some of the first through n-th session maintenance packets may consist of only some of the hole punching message, the MAC keep-alive message, and the ARP response message. In this exemplary embodiment, the transmission interval of the hole punching message may be controlled according to the network environment, and the transmission interval of the MAC keep-alive message may be shorter than the transmission interval of the ARP response message.

For example, when the hole punching message is referred to as “H,” the MAC keep-alive message is referred to as “M,” and the ARP response message is referred to as “A,” a first session maintenance packet may be configured as [H, M, A], a second session maintenance packet may be configured as [M], and a third session maintenance packet may be configured as [M, A]. In this example, by sequentially transmitting the first through third session maintenance packets repeatedly, the wireless communication device 100 can further reduce the amount of data included in each session maintenance packet and can further reduce the consumption of power accordingly.

In another example, when a hole punching setting message, which is a type of hole punching message, is referred to as “H1” and a hole punching-based dummy data transmission message, which is another type of hole punching message, is referred to as “H2,” a first session maintenance packet may be configured as [H1, M, A], a second session maintenance packet may be configured as [H2, M, A], a third session maintenance packet may be configured as [M], and a fourth session maintenance packet may be configured as [M, A]. In this example, the wireless communication device 100 may repeat sequentially transmitting the first, third, and fourth session maintenance packets and then sequentially transmitting the second, third, and fourth session maintenance packets. Alternatively, the wireless communication device 100 may repeat sequentially transmitting the first, third, and fourth session maintenance packets.

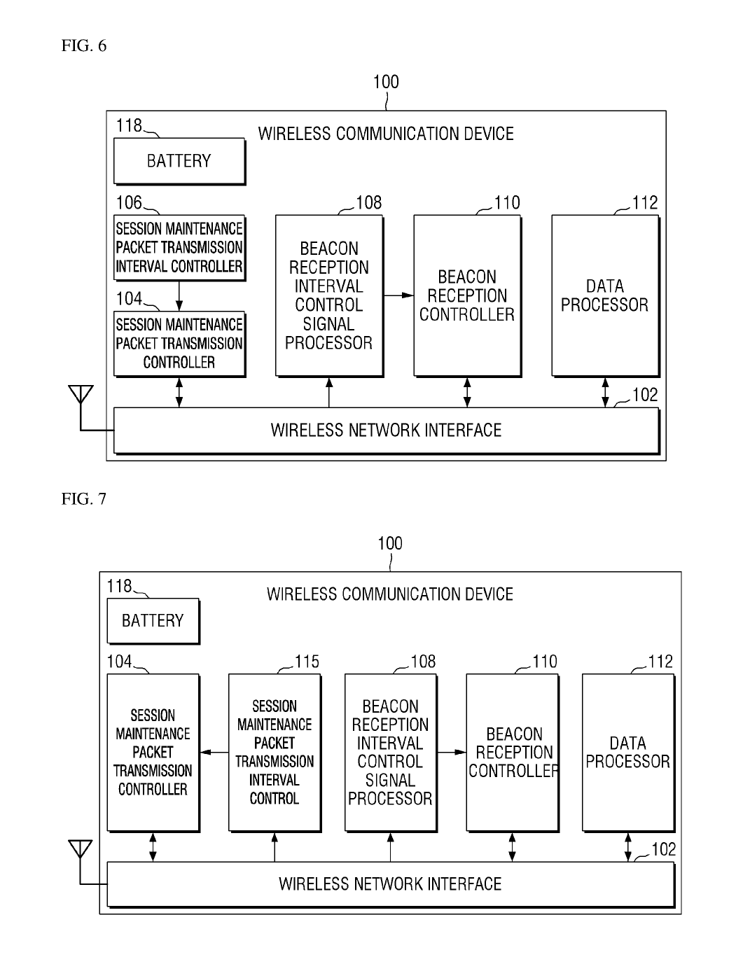

The configuration and operations of a wireless communication device according to an exemplary embodiment of the present disclosure will hereinafter be described with reference to FIG. 6.

Referring to FIG. 6, the wireless communication device 100 includes a wireless network interface 102 and a session maintenance packet transmission controller 104. As described above, the session maintenance packet transmission controller 104 controls the wireless network interface 102 to repeatedly transmit a session maintenance packet including a MAC keep-alive message, an ARP response message, and a hole punching message. In some exemplary embodiments, the wireless communication device 100 may be operated by battery power and may include a battery 118, which supplies power.

The session maintenance packet transmission interval of the wireless communication device 100 may be determined by an AP (not illustrated), to which the wireless communication device 100 is connected via the wireless network interface 102. This means that the session maintenance packet transmission interval of the wireless communication device 100 can be optimized in consideration of the operating characteristics of the AP, and also means that once optimized, the session maintenance packet transmission interval of the wireless communication device 100 does not need to change as long as the AP does not change.

For example, if there is no transaction between an AP and a device connected to the AP for more than a predetermined amount of time, port mapping information regarding the device is reset (or deleted). Then, the device cannot receive any packets having the device as their recipient unless the device transmits packets first. Port mapping resetting is performed only on devices having no transactions with the AP for more than the predetermined amount of time, rather than on all devices connected to the AP.

If the wireless communication device 100 does not transmit any data to the AP 10 for longer than the port mapping reset interval of the AP 10, the AP 10 may reset (or delete) the port and IP address allocated to the wireless communication device 100. Then, a management server (not illustrated) cannot transmit packets to the wireless communication device 100 any longer. To prevent this, the session maintenance packet transmission interval of the wireless communication device 100 may preferably be determined not to be longer than the port mapping reset interval of the AP 10. For example, the session maintenance packet transmission controller 104 may control a session maintenance packet to be transmitted at intervals of an amount of time between a maximum difference subtracted from the port mapping reset interval of the AP and the port mapping reset interval of the AP.

In one exemplary embodiment, the session maintenance packet transmission controller 104 may receive a predetermined session maintenance packet transmission interval from a session maintenance packet transmission interval controller 106 and may control the wireless network interface 102 to repeatedly transmit a session maintenance packet according to the received session maintenance packet transmission interval.

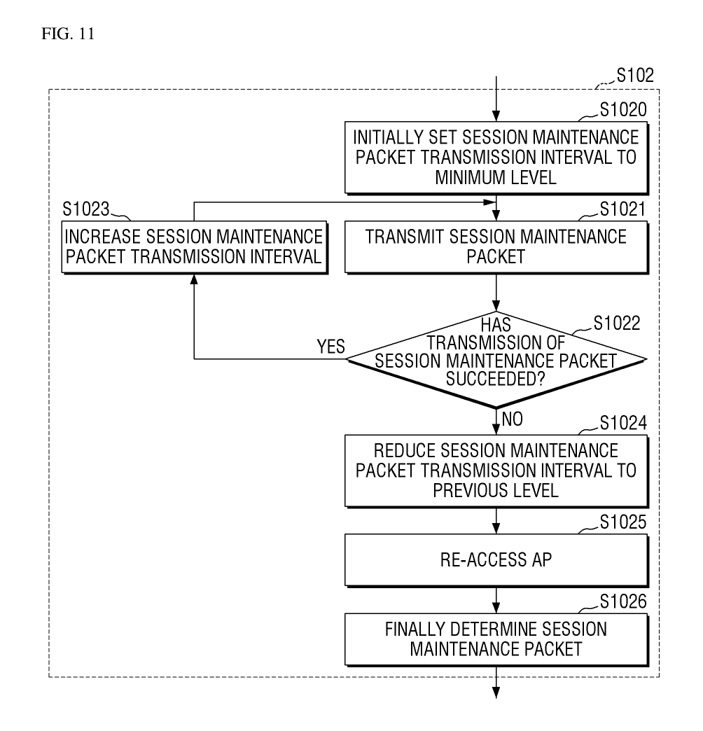

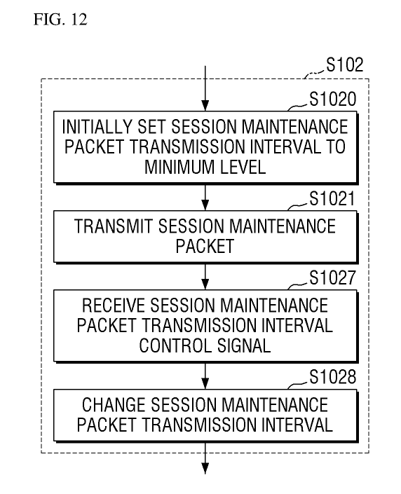

In one exemplary embodiment, the session maintenance packet transmission controller 104 may determine an optimum session maintenance packet transmission interval by gradually increasing the session maintenance packet transmission interval of the wireless communication device 100 from an initial level until a session with the AP is disconnected, and this will be described later with reference to FIG. 11.

In one exemplary embodiment, the session maintenance packet transmission controller 104 may change the session maintenance packet transmission interval of the wireless communication device 100 according to a session maintenance packet transmission interval control signal received from an external device via the wireless network interface 102. The configuration of the wireless communication device 100 according to this exemplary embodiment will hereinafter be described with reference to FIG. 7. Referring to FIG. 7, the wireless communication device 100 may include a session maintenance packet transmission interval control signal processor 115, and the session maintenance packet transmission interval control signal processor 115 extracts a session maintenance packet transmission interval from a session maintenance packet transmission interval control signal received from an external device such as the management server via a wireless network interface 102 and controls a session maintenance packet transmission controller 104 such that a session maintenance packet can be repeatedly transmitted according to the extracted session maintenance packet transmission interval. The extracted session maintenance packet transmission interval may be a session maintenance packet transmission interval mapped to an AP to which the wireless communication device 100 is connected. For example, the management server may identify the type of the AP, may acquire a session maintenance packet transmission interval mapped to the AP from, for example, an AP-specific session maintenance packet transmission interval table, and may insert the acquired session maintenance packet transmission interval in the session maintenance packet transmission interval control signal.

In one exemplary embodiment, the wireless communication device 100 may dynamically change its beacon reception interval. However, this does not necessarily mean that the beacon broadcast interval of the AP changes. The wireless communication device 100 may include the wireless network interface 102 and a beacon reception controller 110.

As the beacon reception interval of the wireless communication device 100 decreases, the latency of signals received from the AP decreases, which means the wireless communication device 100 can readily respond to external signals. On the other hand, as the beacon reception interval of the wireless communication device 100 increases, the latency of signals received from the AP increases, which means the wireless communication device 100 cannot readily respond to external signals.

The wireless communication device 100 may determine whether its beacon reception interval should be changed and may change its beacon reception interval based on the result of the determination. For example, if the level of the battery 118 is below a threshold value, the wireless communication device 100 may increase its beacon reception interval. On the other hand, if the level of the battery 118 becomes higher than the threshold value for reasons such as the charging or the replacement of the battery 118, the wireless communication device 100 may reduce its beacon reception interval.

The wireless communication device 100 may change its beacon reception interval under the control of an external device. To this end, the wireless communication device 100 may include a beacon reception interval control signal processor 108. If a beacon reception interval control signal including an updated beacon reception interval is received by the beacon reception interval control signal processor 108, the beacon reception interval control signal processor 108 may control the beacon reception controller 110 to receive a beacon according to the updated beacon reception interval.

The beacon reception interval control signal processor 108 may receive information regarding a beacon reception interval change schedule and may receive a beacon reception interval control signal whenever there is the need to change the beacon reception interval of the wireless communication device 100. That is, a beacon reception interval control signal received from an external device may include information regarding a beacon reception interval change schedule or may include an updated beacon reception interval for a one-time change of the beacon reception interval of the wireless communication device 100. In other words, in response to information regarding a beacon reception interval change schedule being received, the beacon reception interval control signal processor 108 may interpret the received information and may control the beacon reception controller 110 to change the beacon reception interval of the wireless communication device 100 according to the result of the interpretation. Alternatively, in response to a beacon reception interval control signal including an updated is beacon reception interval being received, the beacon reception interval control signal processor 108 may control the beacon reception controller 110 to change the beacon reception interval of the wireless communication device 100 accordingly.

As already mentioned above, the wireless communication device 100 may be a door lock. A request signal (e.g., a door opening request) transmitted by a user terminal is transmitted to the management server, and the management server transmits the request signal to the wireless communication device 100. Then, the request signal received by the wireless communication device 100 via the wireless network interface 102 is provided to a data processor 112. In response to the request signal being received, the data processor 112 generates a door lock control signal and provides the door lock control signal to a door lock controller (not illustrated). When there are almost no such request signals received, e.g., in the middle of the night, the beacon reception interval of the wireless communication device 100 may preferably be increased. Thus, the management server may set the beacon reception interval of the wireless communication device 100 to be relatively short during the day and relatively long during the night. The beacon reception controller 110 may change the beacon reception interval of the wireless communication device 100 at intervals of a day such that the beacon reception interval of the wireless communication device 100 can be changed to a first interval during a first period of time (e.g., from 7 a.m. to 1 a.m. on the next day) and to a second interval, which is longer than the first interval, during a second period of time (e.g., from 1 a.m. to 7 a.m.), which follows the first period of time.

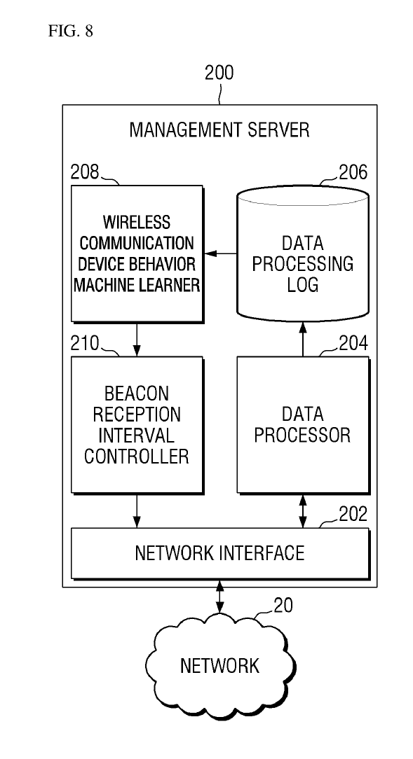

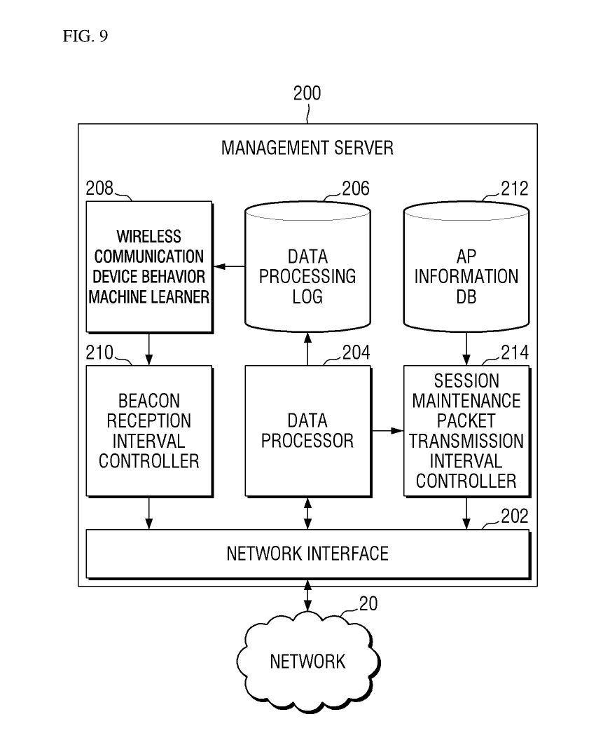

The configuration and operations of a server device according to an exemplary embodiment of the present disclosure will hereinafter be described with reference to FIGS. 8 and 9.

The server device according to an exemplary embodiment of the present disclosure manages a wireless communication network and can thus be referred to as a management server 200. Referring to FIG. 8, the management server 200 may include a network interface 202, which is connected to a network 20, a data processor 204, which processes a wireless communication device-related request received from a user terminal (not illustrated) via the network interface 202, a data processing log 206, which stores at least one logging result regarding the reception of the wireless communication device-related request or the transmission of a control signal for a wireless communication device (not illustrated), a wireless communication device behavior machine learner 208, which generates a model that can determine an appropriate beacon transmission interval, by performing machine learning using data of the data processing log 206 as a training data set, and a beacon reception interval controller 210, which determines the beacon reception interval of the wireless communication device using the model provided by the wireless communication device behavior machine learner 208 and transmits a control signal so as for the wireless communication device to receive a beacon according to the determined beacon reception interval. The management server 200 controls the wireless communication device such that the beacon reception interval of the wireless communication device can be changed according to a record of requests received from a user for the wireless communication device.

The management server 200 is accessed not only by the user terminal, but also by the wireless communication device. The wireless communication device may transmit its state information to the management server 200. The management server 200 may control the session maintenance packet transmission interval of the wireless communication device, and this will hereinafter be described with reference to FIG. 9. Referring to FIG. 9, a session maintenance packet transmission interval controller 214 senses, based on data provided by the data processor 204, that the management server 200 has been accessed by the wireless communication device. Thereafter, the session maintenance packet transmission interval controller 214 searches for and finds a session maintenance packet transmission interval mapped to the AP via which the management server 200 has been accessed by the wireless communication device. Thereafter, the session maintenance packet transmission interval controller 214 transmits a signal controlling the wireless communication device to transmit a session maintenance packet according to the found session maintenance packet transmission interval.

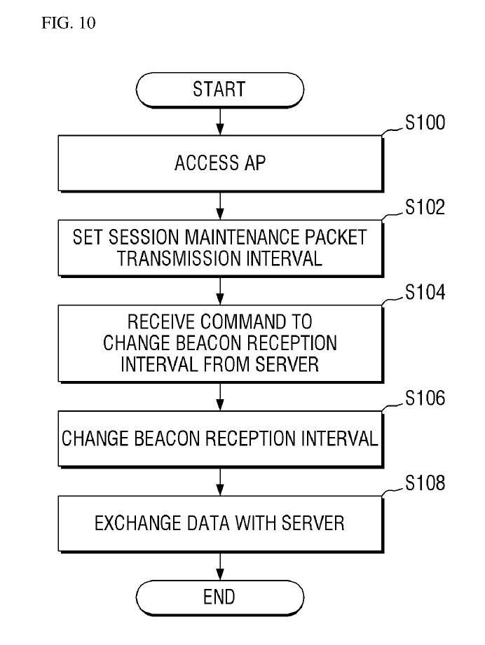

A two-way communication method according to an exemplary embodiment of the present disclosure will hereinafter be described with reference to FIGS. 10 through 12. The two-way communication method according to an exemplary embodiment of the present disclosure may be performed by the wireless communication device 100 of FIG. 6 or 7. At least some of the operations described above with reference to FIG. 6 or 7 may be included in the two-way communication method according to an exemplary embodiment of the present disclosure. Unless specified otherwise, the subject of each step of the two-way communication method according to an exemplary embodiment of the present disclosure may be understood as being the wireless communication device 100.

Referring to FIG. 10, in response to a wireless communication device accessing an AP (S100), the session maintenance packet transmission interval of the wireless communication device is set for maintaining a session with the AP (S102).

An example of the setting of the session maintenance packet transmission interval of the wireless communication device, as performed in S102, will hereinafter be described with reference to FIG. 11. Referring to FIG. 11, the session maintenance packet transmission interval of the wireless communication device is set to a predetermined initial level (S1020). For example, the initial level may be a minimum session maintenance packet transmission interval that can absolutely, but barely, sustain a session in most commercial AP products. Thereafter, a session maintenance packet is transmitted to the wireless communication device (S1021) according to the session maintenance packet transmission interval set in S1020, and if the transmission of the session maintenance packet to the wireless communication device succeeds (S1022), the session maintenance packet transmission interval of the wireless communication device is increased (S1023). S1021, S1022, and S1023 may be repeatedly performed until the transmission of a session maintenance packet to the wireless communication device fails. If the transmission of a session maintenance packet to the wireless communication device fails, the session maintenance packet transmission interval of the wireless communication device is reduced to a previous level, i.e., the level the last time the transmission of a session maintenance packet to the wireless communication device succeeded (S1024). In this manner, a longest session maintenance packet transmission interval that can sustain the session with the AP can be identified. The identified session maintenance packet transmission interval is finally determined (S1026) as the session maintenance packet transmission interval of the wireless communication device and is continuously used after the AP is re-accessed (S1025).

Another example of the setting of the session maintenance packet transmission interval of the wireless communication device, as performed in S102, will hereinafter be described with reference to FIG. 12. In the example of FIG. 12, unlike in the example of FIG. 11, the wireless communication device changes its session maintenance packet transmission interval according to a control signal provided by a server device, without executing session maintenance packet transmission interval optimization logic, and can thus further reduce the consumption of power. Referring to FIG. 12, the wireless communication device uses an initially-set session maintenance packet transmission interval as its session maintenance packet transmission interval (S1020) to transmit a session maintenance packet (S1021). Then, in response to a session maintenance packet transmission interval control signal being received from a management server (S1027), the wireless communication device changes its session maintenance packet transmission interval according to the session maintenance packet transmission interval control signal (S1028).

Referring again to FIG. 10, if a command to change a beacon reception interval is received from the management server (S104) in the middle of periodically transmitting a session maintenance packet to maintain the session with the management server, the wireless communication device changes its beacon reception interval according to the received command (S106). As the beacon reception interval of the wireless communication device increases, the response latency of the wireless communication device increases, but the power consumption of the wireless communication device decreases. On the other hand, as the beacon reception interval of the wireless communication device decreases, the response latency of the wireless communication device decreases, but the power consumption of the wireless communication device increases. The wireless communication device may have some response latency, but can always be connected to the management server by periodically transmitting a session maintenance packet. Thus, the wireless communication device can properly exchange data with the management server (S108).

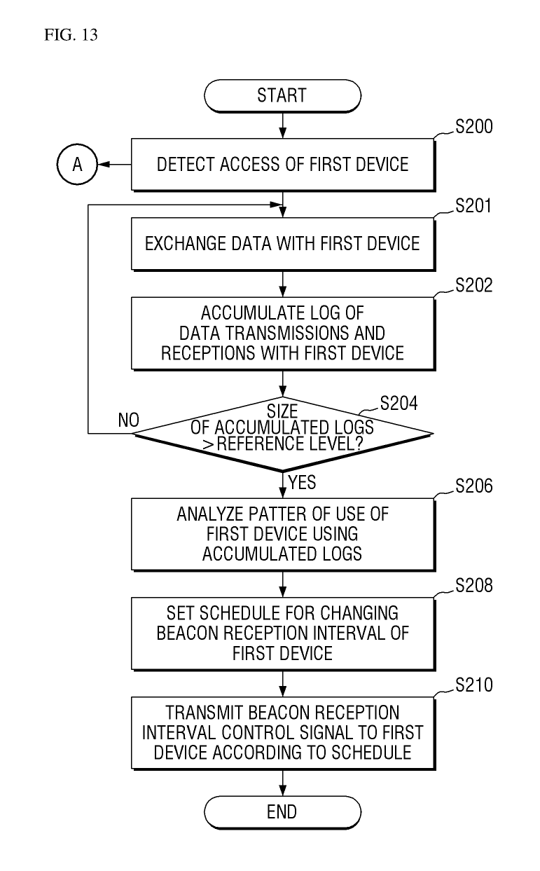

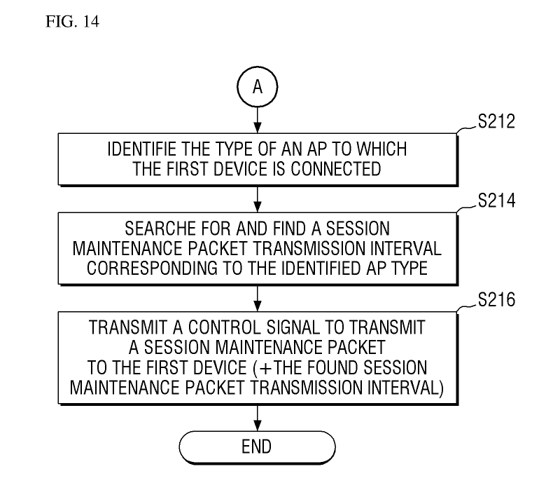

A two-way communication supporting method according to an exemplary embodiment of the present disclosure will hereinafter be described with reference to FIGS. 13 and 14. The two-way communication supporting method according to an exemplary embodiment of the present disclosure may be performed by the management server 200 of FIG. 8 or 9. At least some of the operations described above with reference to FIG. 8 or 9 may be included in the two-way communication supporting method according to an exemplary embodiment of the present disclosure. Unless specified otherwise, the subject of each step of the two-way communication supporting method according to an exemplary embodiment of the present disclosure may be understood as being the management server 200.

Referring to FIGS. 13 and 14, in response to the access of a first device having an unregistered MAC address being detected (S200), a management server may control the initialization of a session maintenance function of the first device. Specifically, the management server identifies the type of an AP to which the first device is connected (S212), searches for and finds a session maintenance packet transmission interval corresponding to the identified AP type (S214), and transmits a control signal (S216) that enables the first device to transmit a session maintenance packet according to the found session maintenance packet transmission interval.

The management server transmits data to, or receives data from, the first device (S201) and keeps and accumulates a log of such data transmissions and receptions with the first device (S202). If the size of the accumulated log exceeds a reference level (S204), the management server analyzes the pattern of use of the first device based on the accumulated log (S206). Specifically, by performing machine learning using the accumulated log as a training data set, the management server may create a model that can classify the pattern of use of the first device and may analyze the pattern of use of the first device using the model.

Once the pattern of use of the first device is analyzed, the management server sets a schedule for changing the beacon reception interval of the first device based on the result of the analysis (S208). For example, the schedule may be set on a daily, weekly, or monthly basis. For example, if the schedule is set on a daily basis, the first device is a door lock installed at the door of an apartment, and the user of the door lock has a pattern of use that involves not transmitting any requests for the door lock during a period of time between 8 a.m. and 8 p.m. every day, the schedule may include transmitting a control signal that increases the beacon reception interval of the first device at 8 a.m. every day and transmitting a control signal that reduces the beacon reception interval of the first device at 8 p.m. every day (S210).

The two-way communication method and the two-way communication supporting method according to exemplary embodiments of the present disclosure may be performed by executing computer programs, which are implemented as computer-readable codes. The computer programs may be transmitted from a first electronic device to a second electronic device via a network such as the Internet to be installed and used in the second electronic device. Examples of the first and second electronic devices include server devices, physical servers included in a server pool for providing a cloud service, and stationary electronic devices such as desktop PCs.

The computer programs may be stored in a non-transitory recording medium such as a DVD-ROM or a flash memory.

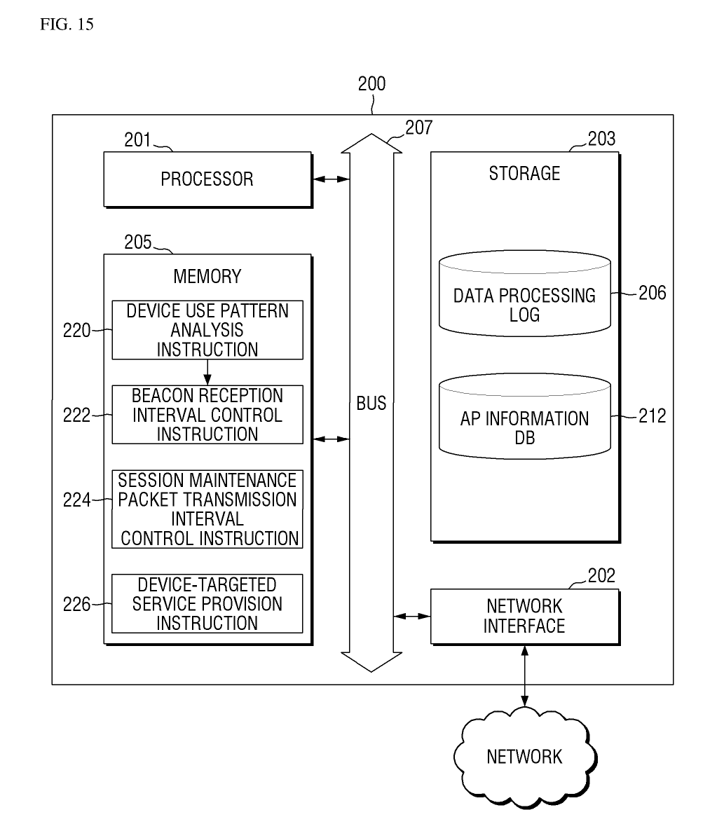

The structure and operations of a server device according to an exemplary embodiment of the present disclosure will hereinafter be described with reference to FIG. 15. Referring to FIG. 15, a management server 200 includes a processor 201 and a memory 205 storing one or more instructions to be executed in the processor 201. The management server 200 may further include a system bus 207, a storage 203, and a network interface 202 connected to a network. The system bus 207 serves as a path via which data is transmitted between the processor 201, the memory 205, the storage 203, and the network interface 202. The memory 205 may be a volatile memory such as a random access memory (RAM). The storage 203 may be a nonvolatile memory such as a flash memory or a data storage such as a hard disk.

The management server 200 receives a request for operating a wireless communication device from a terminal possessed by a user of the wireless communication device or a user who has rights to access the wireless communication device, generates a control signal in response to the received request, and transmits the generated control signal to the wireless communication device.

The management server 200 controls a session maintenance packet transmission function and a beacon reception function of the wireless communication device such that the wireless communication device can maintain a state of being able to perform two-way communication with low power for as long as possible.

The instructions stored in the memory 205 will hereinafter be described. A device-targeted service provision instruction 226 receives a request for operating the wireless communication device from the terminal possessed by the user of the wireless communication device or the user who has rights to access the wireless communication device, generates a control signal in response to the received request, and transmits the generated control signal to the wireless communication device. Histories of such request receptions and control signal transmissions performed by the device-targeted service provision instruction 226 may be accumulated in the data processing log 206.

A device use pattern analysis instruction 220 identifies the pattern of use of the wireless communication device using the data processing log 206, which includes records of the processing of requests for the wireless communication device, and provides the identified pattern of use of the wireless communication device to a beacon reception interval control instruction 222. The device use pattern analysis instruction 220 may identify the pattern of use of the wireless communication device using a model obtained by performing machine learning using at least some data of the data processing log 206 as a training data set.

The beacon reception interval control instruction 222 outputs a signal for controlling the beacon reception interval of the wireless communication device according to the pattern of use of the wireless communication device. The beacon reception interval control instruction 222 may determine the beacon reception interval of the wireless communication device based on the result of the analysis of the data processing log 206 such that as the frequency per unit time of data processing events for the wireless communication device decreases, the beacon reception interval of the wireless communication device increases.

A session maintenance packet transmission interval control instruction 224 performs the operations described above with reference to FIG. 14. That is, the session maintenance packet transmission interval control instruction 224 identifies the type of an AP to which the wireless communication device is connected, searches for and finds a session maintenance packet transmission interval mapped to the identified AP type from an AP information database 212, and outputs a control signal that allows the wireless communication device to repeatedly transmit a session maintenance packet according to the found session maintenance packet transmission interval.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

What is claimed is:

1. A wireless communication device comprising:
a wireless network interface connected to an access point (AP), which provides wireless local area network (WLAN) access; and
a session maintenance packet transmission controller controlling the wireless network interface to repeatedly transmit a session maintenance packet,
wherein the session maintenance packet includes a MAC keep-alive message, an address resolution protocol (ARP) response message, and a hole punching message.

2. The wireless communication device of claim 1, wherein
the session maintenance packet transmission controller controls the wireless communication interface to repeatedly transmit the session maintenance packet periodically, and
a session maintenance packet transmission interval is determined by the AP.

3. The wireless communication device of claim 2, wherein the session maintenance packet transmission controller determines the session maintenance packet transmission interval by gradually increasing the session maintenance packet transmission interval from an initial level until a session with the AP is disconnected.

4. The wireless communication device of claim 2, wherein the session maintenance packet transmission controller changes the session maintenance packet transmission interval according to a session maintenance packet transmission interval control signal received from an external device via the wireless network interface.

5. The wireless communication device of claim 4, wherein the session maintenance packet transmission interval control signal includes information regarding a session maintenance packet transmission interval mapped to the AP.

6. The wireless communication device of claim 2, wherein the session maintenance packet transmission controller determines the session maintenance packet transmission interval not to exceed a port mapping reset interval of the AP.

7. The wireless communication device of claim 1, further comprising:
a data processor generating a door lock control signal according to a request signal received via the wireless network interface and providing the door lock control signal to a door lock controller.

8. The wireless communication device of claim 1, wherein the hole punching message is a hole punching setting message.

9. The wireless communication device of claim 1, wherein the session maintenance packet transmission controller controls the wireless network interface to repeatedly transmit a session maintenance packet including a hole punching setting message, the MAC keep-alive message, and the ARP response message and then a session maintenance packet including a hole punching-based dummy data transmission message, the MAC keep-alive message, and the ARP response message.

10. The wireless communication device of claim 1, wherein the session maintenance packet sequentially includes the hole punching message, the MAC keep-alive message, and the ARP response message.

11. The wireless communication device of claim 1, further comprising:
a beacon reception controller changing a beacon reception interval for beacons transmitted by the AP.

12. The wireless communication device of claim 11, wherein the beacon reception controller changes the beacon reception interval according to a beacon reception interval control signal received from an external device via the wireless network interface.

13. The wireless communication device of claim 11, wherein
the beacon reception controller changes the beacon reception interval periodically at intervals of a day such that the beacon reception interval is changed to a first interval in a first period of time and to a second interval, which is longer than the first interval, in a second period of time, which follows the first period of time, and
the wireless communication device further comprises a data processor generating a door lock control signal according to a request signal received via the wireless network interface and providing the door lock control signal to a door lock controller.

14. The wireless communication device of claim 11, further comprising:
a battery supplying power,
wherein the beacon reception controller changes the beacon reception interval based on the level of the battery.

15. A wireless communication device comprising:
a wireless network interface connected to an AP, which provides WLAN access; and
a session maintenance packet transmission controller controlling the wireless network interface to repeatedly transmit first through n-th session maintenance packets, each having some or all of a hole punching message, a MAC keep-alive message, and an ARP response message, and thus to repeatedly transmit the hole punching message, the MAC keep-alive message, and the ARP response message.

16. A server device comprising:
a network interface providing a connection to a wireless communication device and a connection to a user terminal;
a memory storing one or more instructions; and
a processor executing the one or more instructions,
wherein the one or more instructions include an instruction receiving a request for the wireless communication device from the user terminal and transmitting a control signal for the wireless communication device in response to the received request, an instruction logging at least one of the reception of the request and the transmission of the control signal so as to configure a data processing log, an instruction determining a beacon reception interval of the wireless communication device based on a result of analyzing the data processing log, and an instruction transmitting a beacon reception interval control signal that changes the beacon reception interval of the wireless communication device to the determined beacon reception interval to the wireless communication device.

17. The wireless communication device of claim 16, wherein the instruction determining the beacon reception interval of the wireless communication device, determines the beacon reception interval of the wireless communication device using a model obtained by performing machine learning using the data processing log as a training data set.

18. The wireless communication device of claim 16, wherein the instruction determining the beacon reception interval of the wireless communication device, determines the beacon reception interval of the wireless communication device such that as a frequency per unit time of data processing events for the wireless communication device decreases, the beacon reception interval of the wireless communication device increases.

19. A wireless communication device comprising:
a wireless network interface connected to an AP, which provides WLAN access;
a beacon reception controller changing a beacon reception interval for beacons transmitted by the AP; and
a battery supplying power,
wherein the beacon reception controller changes the beacon reception interval based on the level of the battery.

20. A wireless communication device comprising:
a wireless network interface connected to an AP, which provides WLAN access; and
a beacon reception controller changing a beacon reception interval for beacons transmitted by the AP,
wherein the beacon reception controller changes the beacon reception interval according to a beacon reception interval control signal received from an external device via the wireless network interface.
